(19) United States
(12) Patent Application Publication
(10) Pub. No.: US 2009/0265624 A1
(43) Pub. Date: Oct. 22, 2009

(54) ELECTRONIC FORMS PREPARING AND MANAGING SYSTEM, ELECTRONIC FORMS PREPARING AND MANAGING PROGRAM, AND PROGRAM STORING MEMORY MEDIA

(76) Inventor: Reiji Fukuda, Tokyo (JP)

Correspondence Address: DICKSTEIN SHAPIRO LLP, 1825 EYE STREET NW, Washington, DC, 20006-5403, US

(21) Appl. No.: 12/105,999

(22) Filed: Apr. 18, 2008

(51) Int. Cl. G06F 3/14

(52) U.S. Cl. 715/273

(57) ABSTRACT

An electronic forms preparing and managing system in which electronic forms data are selected from a memory of a computer, new electronic forms having an optional format are prepared using the selected data, and are shown on a monitor of the computer. The electronic forms preparing and managing system includes a data creating unit changing the optional format data on the electronic forms into object format data, and a unit hierarchically defining access rights to the object format data.

### FIELD OF THE INVENTION

This invention relates to a system and a program applied to safely preparing and managing electronic forms.

### DESCRIPTION OF THE RELATED ART

A variety of systems and programs have been proposed in order to prepare electronic forms of particular formats. Such systems and programs enable computers to input data necessary for creating electronic forms in memories. Necessary data are selected from the memories. Inputted data respond only to the format defined by the system or program. Therefore, when forms of a different format should be prepared, it is necessary to construct a new forms preparing and managing system, and further data inputting work is required, which is expensive and time consuming.

Japanese Patent Laid-Open Publication No. 2002-189627 has proposed a method of applying data, which have been used to create electronic forms using an existing electronic forms preparing and managing system, to electronic forms having a different format.

### PROBLEMS TO BE SOLVED BY THE INVENTION

The foregoing related art describes how to apply the electronic forms data of a given format to electronic forms of the different format, but does not refer to anything about safe data management such as who is authorized to create and use the electronic forms.

There is a lot of well-known software for an electronic documentation of existing data in the Portable Document Format (PDF). It is possible to assign an access right (computer security) to each computerized form. However, when changing contents of the computerized form, it is necessary to return the computerized form to the original format, and to rewrite it in the PDF. Therefore, it is very time consuming to change or update data

There is no available electronic forms preparing system which enables a new data table to be prepared in a database or the data to be rewritten in the database by accessing the electronic forms preparing and managing system from an outside.

### SUMMARY OF THE INVENTION

The present invention intends to provide a system, a method and a program which enables data in electronic forms to be changed and data in a database to be changed while maintaining the security of the data.

In order to accomplish the foregoing object, a first feature of the invention is an electronic forms preparing and managing system in which electronic forms data are selected from a memory of a computer, new electronic forms having an optional format are created using the selected data, and are shown on a monitor of the computer. The electronic forms preparing and managing system comprises a data creating unit changing the optional format data into object format data, and a unit hierarchically defining access rights to the object format data.

With the foregoing system, the object format data can be changed by the user's terminal in accordance with an access right thereof.

In accordance with a second feature of the invention, there is provided an electronic forms preparing and managing system in which electronic forms data are selected from a memory of a computer, new electronic forms having an optional format are prepared using the selected data, and are shown on a monitor of a user's terminal accessible to the computer via a network. The electronic forms preparing and managing system comprises a data creating unit changing an optional format data into object format data, and a unit hierarchically defining access rights to the user's terminal, which allows the user's terminal to gain access to the object format data.

With the foregoing system, the object format data can be changed by the user's terminal in accordance with an access right thereof.

Further, the electronic forms data can be rewritten into the changed object format data in response to a command from the user's terminal having the access right to the memory.

Still further, the user's terminal can gain access to the memory in accordance with the access right thereof. In response to the command from the user's terminal having the access right, a new data table can be stored in the memory, and object input regions corresponding to the data table can be created on the electronic forms.

According to a third feature of the invention, there is provided an electronic forms preparing and managing program installed in a computer and enabling the computer to execute the following: selecting electronic forms data from a memory; preparing electronic forms of an optional format on the basis of the selected data; showing the electronic forms on a monitor; changing the optional format data into object format data; and hierarchically defining access rights to the object format data.

The program enables the computer to execute the step for changing the object format data in accordance with the access right.

In accordance with a fourth feature of the invention, there is provided an electronic forms preparing and managing program installed in a computer and enabling the computer to execute the following: selecting electronic forms data from a memory; creating electronic forms of an optional format on the basis of the selected data: showing the electronic forms on a monitor of a user's terminal accessible to the computer via a computer network; changing the electronic forms data of the optional format into object format data; and hierarchically defining access rights to the object format data.

The program enables the computer to change the object format data in accordance with the access right of the user's terminal having the access right.

Further, the program enables the computer to rewrite the electronic forms data stored in the memory into the changed object format data in response to the command from the user's terminal.

Still further, the program enables the computer allows the user's terminal to gain access to the memory in accordance with the access right thereof, and creates data tables for storing new data in the memory and an object format data input area on the electronic forms, the object format data input area corresponding to the data table.

The foregoing program) is stored in a recording medium.

The electronic forms preparing and managing system comprises a data preparing unit changing the optional format data on the electronic forms into data in an object format, and a unit hierarchically defining access rights to the object format data. It is possible to change the object format data on the electronic form in accordance with the access right, and further to change the data on the electronic form while retaining the safety of the data. The electronic forms can be managed with convenience.

Further, the electronic forms preparing and managing system comprises a data preparing unit changing the optional format data on the electronic forms into data in an object format, and a unit hierarchically defining the access right by which the user's terminal gains access to the object format data. It is possible to change object format data on the electronic form in accordance with the access right, and further to change the data on the electronic form while retaining the safety of the data. The electronic forms can be managed with convenience.

According to the invention, the user's terminal can gain access to the memories in accordance with the access right thereof. The object format data changed in response to the command of the user's terminal can be rewritten as electronic forms data in the memory. The changed data on the electronic forms are stored in the memory, so that it is possible to assure uniformity of the data.

Finally, in response to the command from the user's terminal having the access right to the memories, the data table for storing new data in the memory and the object data input area corresponding to the data table are created on the electronic forms. Therefore, the new data can be added to the electronic forms and the memories. The system of the invention can be accomplished without requiring an additional new and complicated system compared with a system of the related art. It is possible to reduce a cost for developing a new system, and to change the data on the electronic forms with safety and convenience.

### BRIEF DESCRIPTION OF THE DRAWINGS

FIG. 1 is a block diagram of an electronic forms preparing and managing system according to one embodiment of the invention.

FIG. 2 is a flowchart showing processes executed by the electronic forms preparing and managing system.

FIG. 3 is a flowchart showing a user registering process.

FIG. 4 is a flowchart showing a database selecting process.

FIG. 5 is a flowchart showing how to register information for the database selection (shown in FIG. 4).

FIG. 6 is a flowchart showing how to register table information (prepared in the process shown in FIG. 4).

FIG. 7 is a flowchart how a query is created in the process shown in FIG. 4.

FIG. 8 is a flowchart showing how to design forms and how to define security to each object.

FIG. 9 is a flowchart showing how to register a quick report.

FIG. 10 is a flowchart showing how to process access from a terminal in a client/server environment.

FIG. 11 is a flowchart showing how to process access from a terminal via the Internet.

FIG. 12 is a flowchart showing how to edit an electronic form in an object format.

FIG. 13 is a flowchart showing how to change and add contents of the object format electronic form in the database.

FIG. 14 is a flowchart showing how to change the object format electronic forms in the database via a LAN (local area network).

FIG. 15 is a flowchart showing how to change the object format electronic forms in the database via the Internet.

FIG. 16 is a block diagram showing how to batch-process a plurality of object format electronic forms in order to change them in a memory.

FIG. 17 shows one example of screens for a user registering process.

FIG. 18 shows one example of screens for a query creating process.

FIG. 19 shows another example of screens for the query creating process.

FIG. 20 shows one example of screens for in a form designing process.

FIG. 21 shows one example of screens for a print condition selecting process.

FIG. 22 shows one example of screens for an access right defining process for the object format electronic forms, and a configuration of the electronic forms.

FIG. 23 shows one example of screens for creating a query when updating data in the memory using the object format electronic form.

FIG. 24 shows one example of screen for an access right defining process.

FIG. 25 shows a system configuration for defining the access right.

FIG. 26 shows one example of screens for a login process.

FIG. 27 shows one example of screens displayed on a logged-in user's terminal.

FIG. 28 shows one example of previewing screens displayed on the login user's terminal.

FIG. 29 shows one example of screens shown on the logged-in user terminal.

FIG. 30 shows how a browsing and editing right is defined to the user with respect to the object format electronic data, and showing how the user identification is displayed on a screen.

FIG. 31 shows how to assure traceability of the object format electronic form.

FIG. 32(a) shows one of screens indicating contents of traceability.

FIG. 32(b) shows one example of screens indicating changed contents.

FIG. 33 shows an overall configuration of an electronic forms preparing and managing system in a further embodiment of the invention.

### DETAILED DESCRIPTION OF THE INVENTION

The invention will be described with reference to the drawings. An electronic forms preparing and managing system adopts a server/client configuration, or is constituted by one computer. The server/client configuration will be described first.

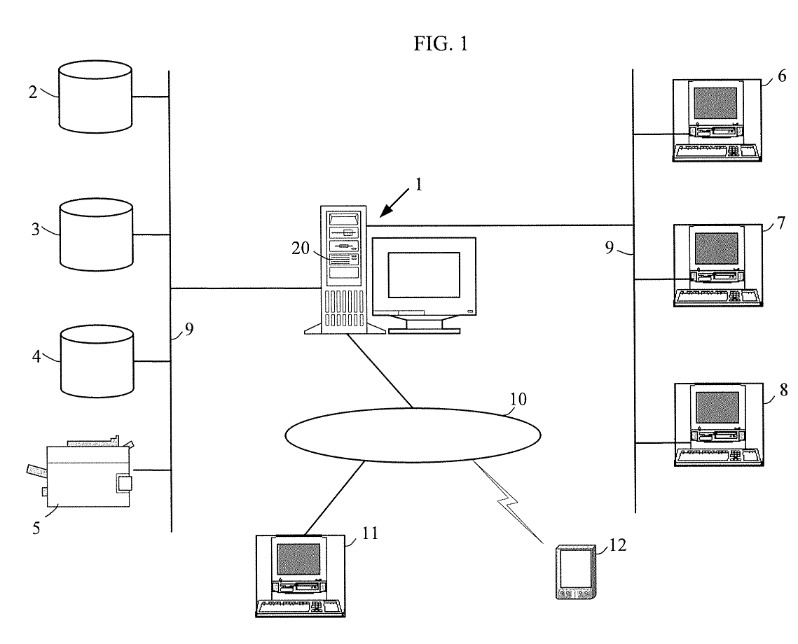

Referring to FIG. 1, the electronic forms preparing and managing system comprises a server 1, memories 2, 3 and 4, a printer 5, and terminals 6, 7 and 8 as clients' machines. The memories 2, 3 and 4, printer 5 and terminals 6, 7 and 8 are connected to, gain access to and communicate with the server 1 via a local area network 9 (LAN).

Further, the electronic forms preparing and managing system is also applicable to a configuration in which terminals 11 and 12 such as personal digital assistants (PDAs), portable personal computers or portable phones are accessible to the server 1 via the Internet 10 as a public network. In such a case, the terminals 11 and 12 are a part of the system, but may be distant from the server 1 or may be carried by sales people. Further, the terminals 11 and 12 may be independent from the system, but are selectively connected to the system. The terminals 6 to 8, and 11 and 12 are used by users in order to gain access to the server 1.

An electronic form preparing and managing program is installed in the server 1 using a memory such an optical disc (not shown) or is downloaded via the Internet 10. Once provided with the foregoing program, the server 1 executes the following tasks: selecting electronic forms data in a given format from a data file 20 in the memory 2, 3 or 4, or a memory of the server 1; creating a new electronic form using the selected data, the new electronic form having a format different from a given format; storing the new electronic form in the data file 20 of the server 1; showing created electronic information on monitors of terminals which are accessible to the server 1; creating data, (which are in the electronic form and have an optional format), in an object format; assigning hierarchical access rights to the electronic forms data in the object format; defining the terminals hierarchical access rights to access the electronic forms and/or the data file 20; and hierarchically indicating only the electronic forms or the data file 20 on the terminals in accordance with the access rights.

The memories 2, 3 and 4 are databases applicable to different purposes. The memories 2 to 4 are called the databases 2 to 4 hereinafter. The database 2 is for sales management. The database 3 is for accounting. The database 4 is for manufacturing management. The databases 2, 3 and 4 store electronic forms data which are organized in formats according to the foregoing purposes. Specifically, the databases 2, 3 and 4 are incorporated when the electronic forms preparing and managing system is configured, and part of existing operating systems adopted by the user having the server 1. Needless to say, new databases 2 to 4 may be incorporated into the electronic forms preparing and managing system. The printer 5 is a network printer, and prints data in response to a print command from the server 1, or print commands from terminals 6 to 8 via the LAN 9.

The terminals 6 to 8, 11 and 12 are provided with programs for logging in the server 1. When the user activates the login program and enters his or her name and password, the server 1 compares the user's login information with stored login information, and allows the user to access the server 1.

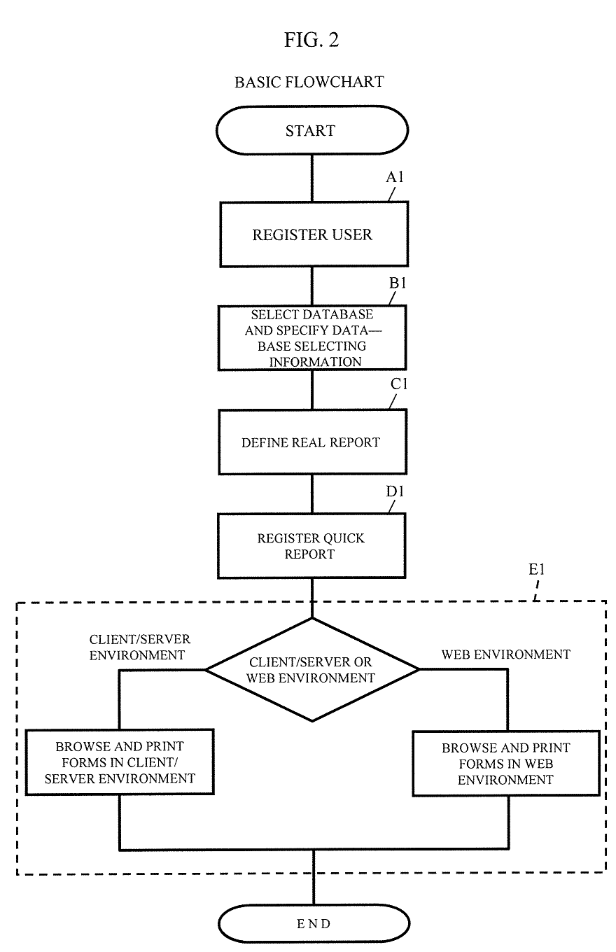

The server 1 is provided with a program. In response to the program, the server 1 executes the following (shown in FIG. 2): a user registering process for registering the user at the terminal 6, 7, 8, 11 or 12 (step A1); a database selecting process (step B1) for selecting a database 2, 3 or 4 from which the data should be selected (called the “database (DB) selection process”): a real report creating process (step C1) to determine what format an electronic form has on the basis of the selected data; a quick report registering process (step D1) for registering a compatible format for a viewer file (called “PVF”) having a given format for sentences or table calculation; and a switching process (step E1) for switching screens on a monitor of the user's terminal depending upon a network via which the terminal has accessed the server 1. The term “PVF” represents that the written data are of the object format, and can be independently rewritten. According to the invention, access rights are defined to the object format data which have been prepared in the PVF format on the electronic forms. Further, the terminals can rewrite the data in the object format on the electronic forms in accordance with the access rights.

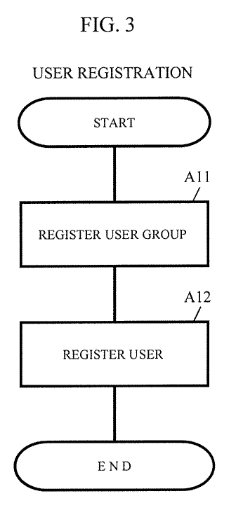

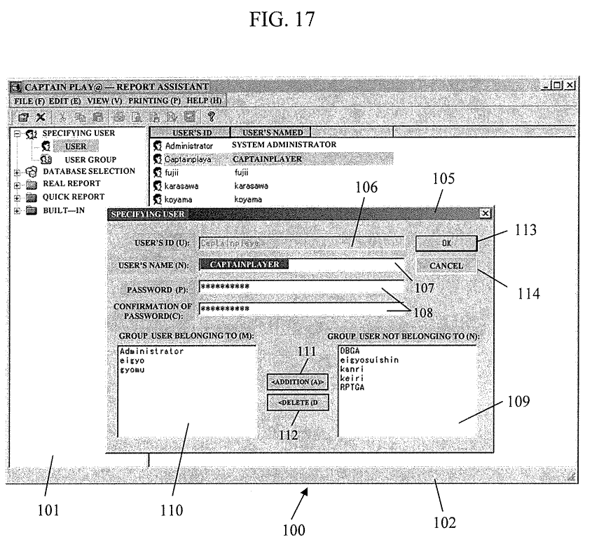

The processes executed by the electronic forms preparing and managing system will be described with reference to FIG. 3 to FIG. 16. FIG. 17 to FIG. 29 show screens appearing on the monitor of the server 1 and on monitors of the respective terminals. When a startup icon (not shown) of the server 1 is clicked, the startup program is initiated, so that an initial screen 100 (FIG. 17) is appears on the monitor of the server 1 or on the monitor of the terminal, and shows a variety of icons for executing the foregoing processes. Screens 101 and 102 show details of the processes to be executed. FIG. 17 shows a screen for the user registering process as an example.

Referring to FIG. 3, a user group using the electronic forms preparing and managing system is registered in step A11, and each user in the registered user group is registered in step A12.

The user registering process is started as shown on FIG. 3 when the user clicks a USER GROUP icon on the screen 101 (FIG. 17). In the user registering process, an entry screen (not shown) appears. The operational person of the server 1 inputs the group name and an ID, and clicks an “OK” tug (not shown). The group name and ID are correlated and stored in a data table (not shown) of the server 1.

An operational person at the server 1 clicks a “USER” icon on the screen 101, which initiates the user registering process. A screen 105 appears, and has the following areas and buttons: areas 106, 107 and 108 for entering the user's ID, name and password; an area 109 showing the registered group names; an area 110 showing the group name where the user should be registered; an “ADD” button 111 and a “DELETE” button 112 for defining the relationship between the registered user's name and the group; and an “OK” button 113 and a “CANCEL” button 114 for determining whether or not the contents of the user registering process should be stored in the data table 20 (not shown).

When the operational person at the server 1 enters the ID, name and password, the user group to which the users belong and which is designated by pressing the “ADD” button 111 will be selected. Then, the “OK” button 113 is clicked, so that the data of the selected user are correlated and are stored in the data table (not shown).

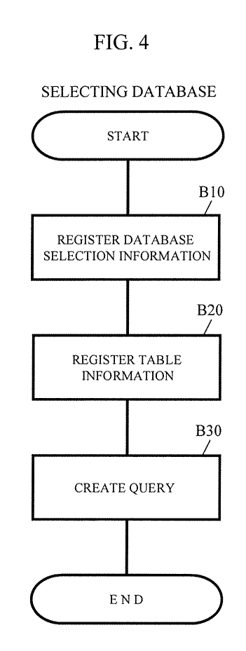

The DB selection process (shown in FIG. 4) is started by clicking a “DB SELECTION” icon on the screen 101 (shown in FIG. 17).

DB selection information is registered in step B10, and table information is registered in step B20. A query is created in step B30.

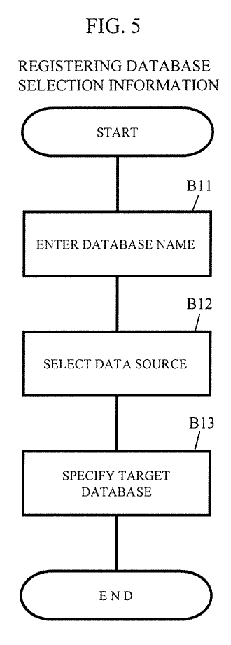

For the DB selection information registering process in step B10 (FIG. 5), a name of the database to be selected is entered in step B11 on the entry screen (not shown). In step B12, a data source is selected for creating an electronic form. In step B13, a target database is entered on the basis of the data source selected in step B12. Specifically, data of drivers which are compatible with a plurality of databases 2 to 4 are stored in the memory of the server 1. A list of the drivers is shown on the monitor of the server 1 or the monitors of the terminals 6 to 8. The data of the selected database is stored in the data table of the server 1.

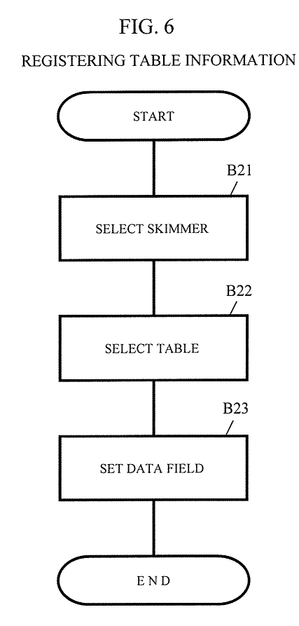

In the table information registration in step B20 (shown in FIG. 4), a skimmer is selected in step B21 (shown in FIG. 6), a table is selected in step B22, and a data table is selected in step B23.

Specifically, in step B21, a list of skimmers, which are registered in accordance with the databases registered in step B10 (shown in FIG. 4), is shown on the monitor of the server 1 or monitors of the terminals 6 to 8. The operational person at the server 1 or at the terminal selects one of the skimmers on the pop-up screen. In step B22, a list of data tables, which are controlled by the skimmers, is shown on the monitor of the server 1 or monitors of the databases 6 to 8. The operational person at the server 1 or at the terminal selects one of the data tables. In step B23, a data field of the selected data table is shown on the monitor of the server 1 or monitors of the terminals 6 to 8. Items or columns representing the data fields are given in alphanumeric characters, which may be converted into Japanese systems of syllabication, or Japanese names. Results of the foregoing processes are stored in the data table of the server 1.

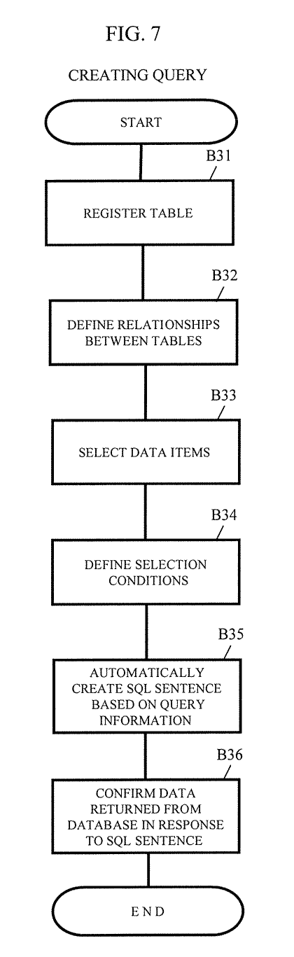

For the query creating process in step B30 (shown in FIG. 4), steps shown in FIG. 7 are executed: a table registering process (step B31); a table correlating process (step B32); a data item selecting process (step B33); a selection condition determining process (step B34); an automatic SQL document creating process (step B35); and a process (step B36) for confirming the executed SQL document creating process.

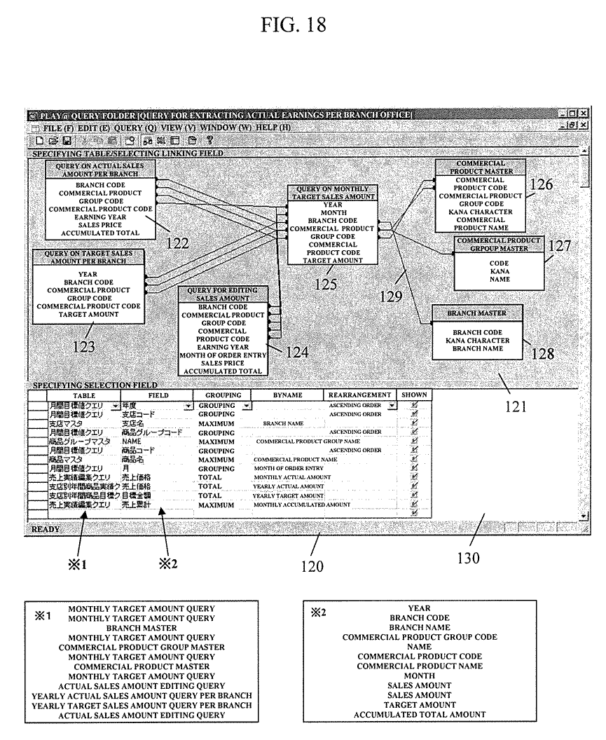

In steps B31 to B33 (shown in FIG. 7), the monitor of the server 1 indicates a screen 120 as shown in FIG. 18. During step B31, rectangular areas 122 to 128 at an upper part of a table selecting/field linking screen 121 serve as tables, where data necessary for creating the query are stored. In step B32, the tables 122 to 128 are correlated. The correlated tables are indicated on the screen 121 using linking lines 129.

In step B33, data items necessary for creating the electronic form are selected on a selection field area 130 (shown at a lower part of the screen 120). Specifically, the selection field area 130 shows an input section for specifying data items such as the table name, field and grouping. The selected data items are correlated to the tables and fields, are shown on the monitor of the server 1, and are stored in the memory of the server 1 (not shown).

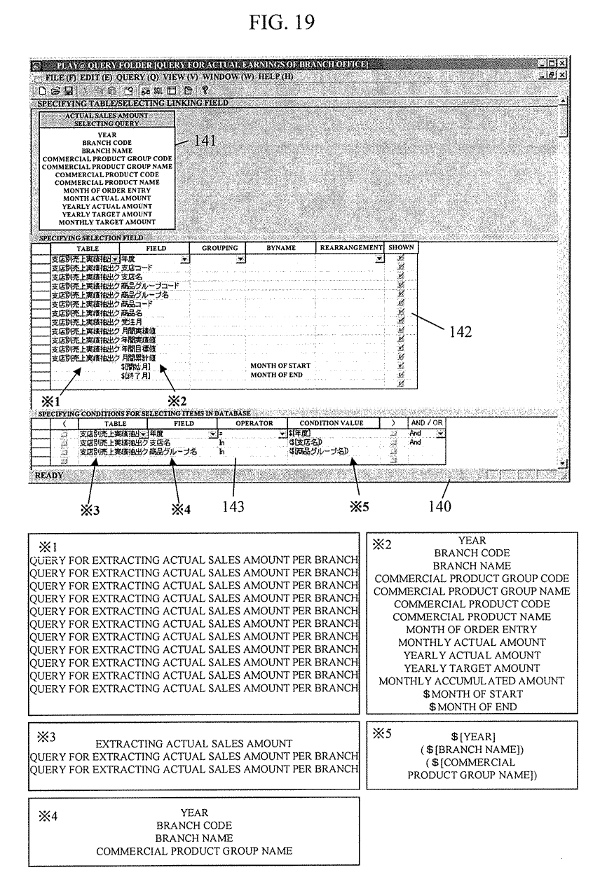

In step B34 (shown in FIG. 7), a screen 140 is used as shown as in FIG. 19. The screen 140 shows a table selecting/field linking 141, a selection field area 142, and a condition field area 143. When refining the stored data items, items of selection conditions are specified on the condition field area 143.

In this state, the automatic creation of the SQL document is executed in step B35, which is confirmed in step B36. Results of the confirmation are stored in the memory (not shown) of the server 1.

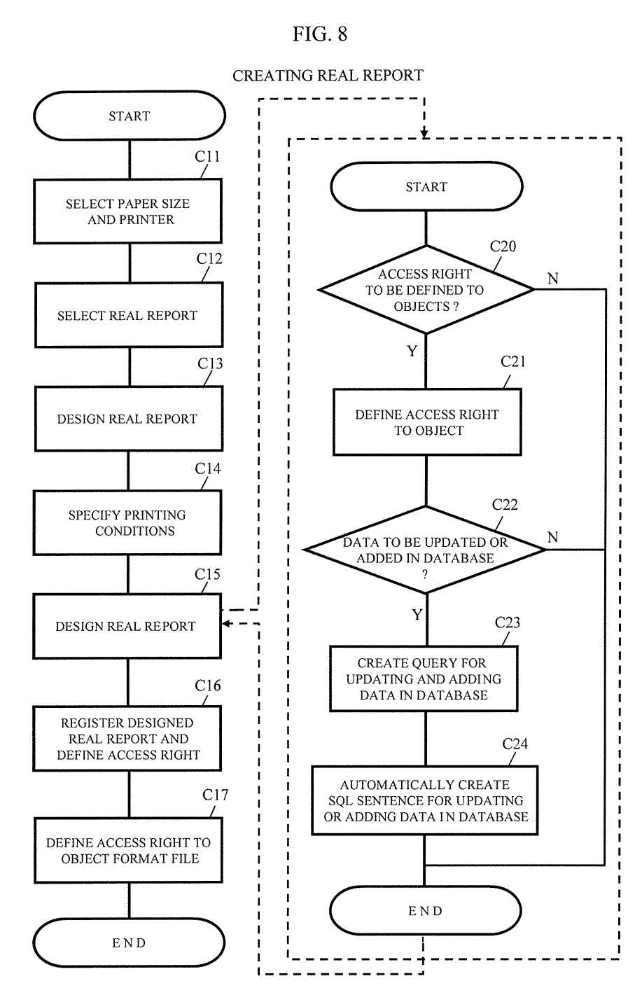

In a real report (a model electronic form) creating process (step C1 shown in FIG. 2), the following are executed as shown in FIG. 8: selecting a paper size/printer (step C11); selecting a real report (C12); designing a real report (step C13); specifying printing conditions (step C14); designing the real report (step C15); registering the designed real report and defining access rights (step C16); and defining access rights to the object file (PVF) (step C17).

In step C11, the operational person at the server 1 enters a size of the real report, and selects a default printer. Contents of the items in step C11 are stored in the memory of the server 1.

In step C12, a data source to be used for designing the real report is selected on the basis of the query created for the database selection (step B1). The data of the selected data source is stored in the memory of the server 1.

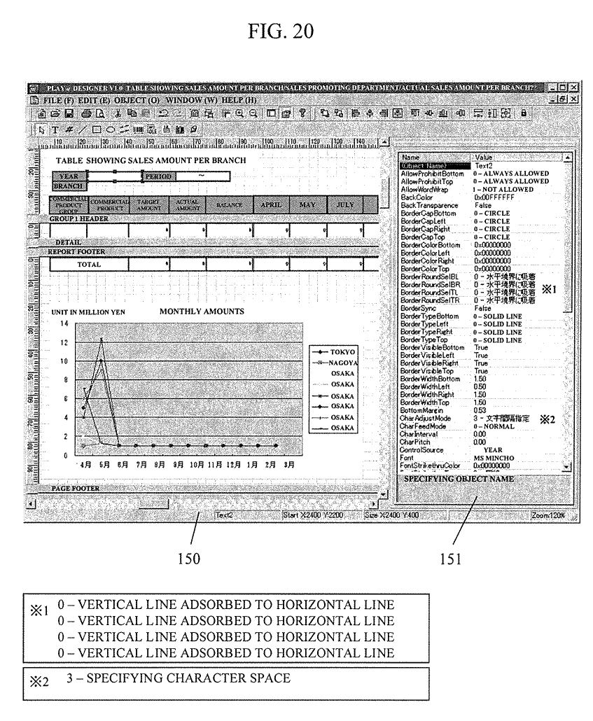

During step C13, a screen 150 appears on the monitor of the server 1 or the monitors of the terminal 6 to 8 as shown in FIG. 20. The screen 150 offers ten kinds of objects such as a text frame, a numerical frame and so on. The electronic form having a given format can be designed by selectively arranging objects. By clicking a property area 151 or a script area at the right part of the screen 150, the operational person at the server 1 or at the terminal refines the design of the real report, and determines printing conditions. The entered data are stored in the memory of the server 1.

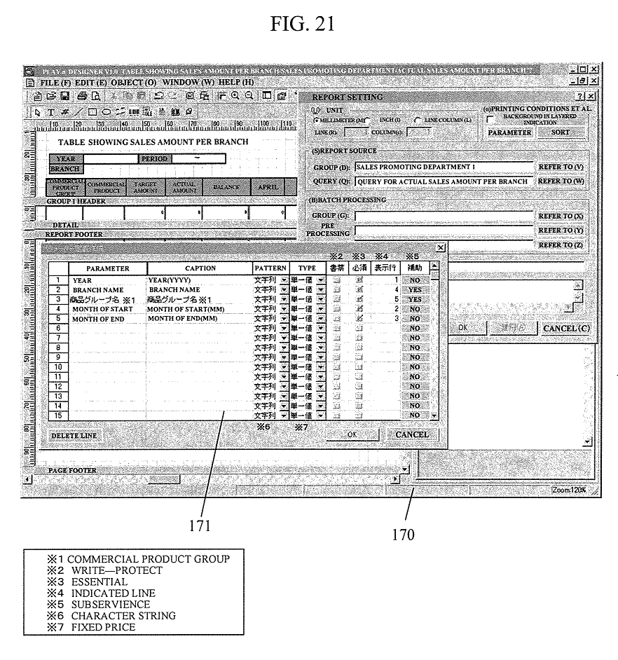

In step C14, a screen 170 (shown in FIG. 21) appears on the monitor of the server 1. The operational person at the server 1 manipulates an input area 171 in order to specify the printing conditions. The specified conditions are stored in the memory of the server 1.

For step C15 (real report designing process), it is checked in step C20 (FIG. 20) whether or not access rights should be defined to the respective objects (to be included in the electronic form). If no access right should be defined, step C15 will be terminated. On other hand, when the operational person at the server 1 clicks a set-up button, the access rights are considered to be defined to the objects, and step C21 will be executed.

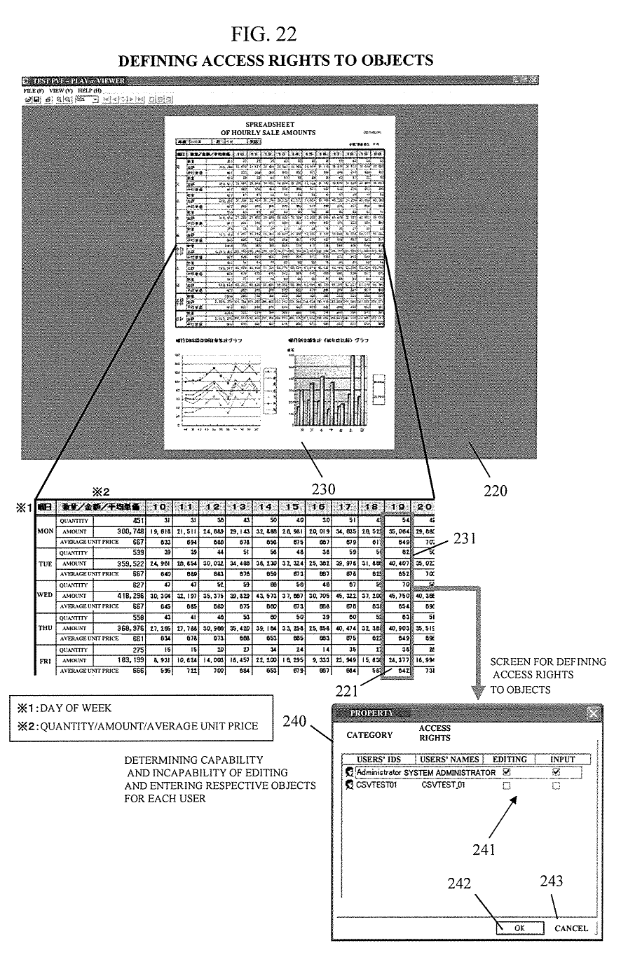

In step C21, a screen 220 (shown in FIG. 22) appears on the monitor of the server 1 or monitors of the terminals 6 to 8. An electronic form 230 constituted by a plurality of objects 221 is shown on the screen 220. When one of the objects 221 to which the access right should be defined are selected, a screen 240 appears over the screen 220. The screen 240 shows users' IDs and names, contents 241 of the access rights, an “OK” button 242 for entering the access right, and a “CANCEL” button 243 for cancelling the access right. In the example of FIG. 22, the same access right is defined to all of the objects 221 enclosed by an area 231. The access right enables or disables updating, editing and inputting the objects 221 in the area 231. In this embodiment, the operational person at the server 1 is allowed to edit and input the respective objects 221 in the area 231. When an OK button 241 is clicked by using a mouse or the like, the set up contents become definite. Then, step C22 will be executed.

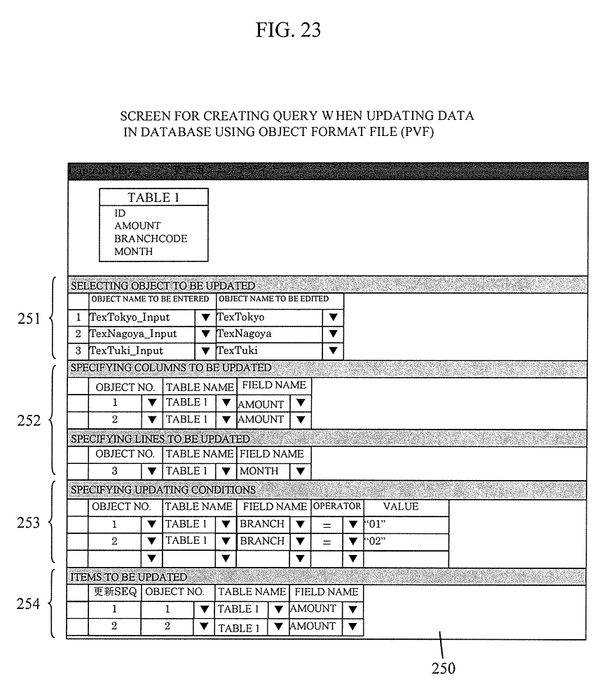

In step C22, it is checked whether or not the data should be changed or added in the database. If not, step C22 will be terminated. On the other hand, when the data should be changed or added, step C23 will be executed. A screen 250 appears on the monitor of the server 1 or the monitors of the terminals 6 to 8 as shown in FIG. 23. The screen 250 is used to cerate a query for updating the data stored in the databases 2 to 4. The screen 250 has an object updating part 251, a column-and-line selecting part 252 for selecting a column and a line of objects to be changed and added, a part 253 for minutely defining updating conditions, and an object selecting part 254 for selecting objects to be changed. The objects to be changed or added are shown at the object updating part 251. A position of the object to be changed or added is shown at the column-and-line selecting part 252 as object numbers, table names and field names. The part 253 shows the object numbers, table names, field names, operators, and values. The selecting part 254 shows SEQ to be changed, object numbers, table names, and field names as the objects to be changed. The operational person at the server 1 specifies contents of the foregoing items, so that the updating/adding query is created in order to change and add data in the databases 2 to 4. In step C24, an SQL document will be automatically created on the basis of the contents specified in step C23. The created SQL document will be stored in the memory of the server 1. In this state, a series of processes will be finished.

In step C16 for registering the designed real report, the items processed in steps C11 to C16 are correlated as master data for one electronic form, and are stored in the memory of the server 1. Further, access rights are hierarchically defined as to who can browse or print the registered data file. Definition of the access right is executed for each user or each group.

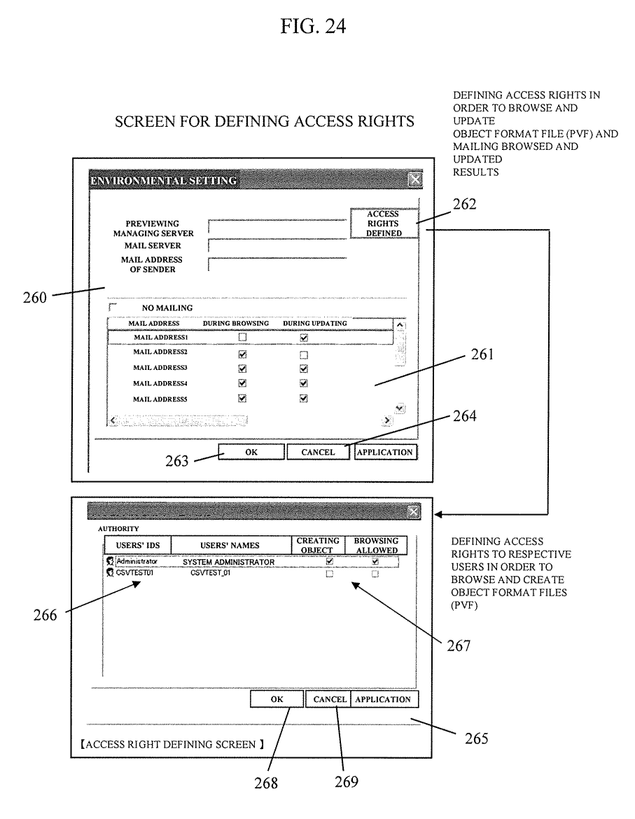

Referring to FIG. 24, a screen 260 appears on the monitor of the server 1 when the access rights are defined to the object format file (PVF) in step C17. The screen 260 is an initial screen, and shows the following: an addressee selecting part 261 used to mail information indicating that the object format file (PVF) has been browsed and changed; an access right button 262 used to select an access right screen 265; a button 263 making the selected access right definite; and a button 264 for cancelling the selected access right. The addressee selecting part 261 hierarchically defines the access rights to the addressees.

The access right screen 265 includes a hierarchical user information part 266, an access right defining part 267, a button 268 for making the defined access right definite, and a button 269 for cancelling the defined access right. The access rights are defined for respect users to browse the object format files (PVF), and to create objects. A user information part 266 shows IDs and names of the users' terminals. The security right defining part 267 is configured to enable and disable creating and browsing the object format files. When the access right defining part 267 is clicked and the button 268 is clicked, the defined access right becomes definite. When the button 263 on the screen 260 is clicked, the real report creating process will be completed.

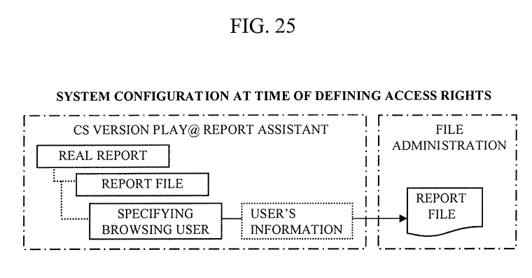

Specifically, in the real report creating process shown in FIG. 25, the new report file in the object format is created based on the report file containing the selected data in the optional format, and based on the information of the user allowed to browse data. The new report file is stored in the memory of the server 1. Referring back to FIG. 8, in the real report design registering process (step C15), the data of the report file in the optional format is used to create an electronic form 230 having the object format. Further, the access rights for the terminals to gain access to the object format data (the objects 221 constituting the electronic form 230) are hierarchically defined. On the basis of the access rights, the terminals are enabled to change the object format data (the objects 221 constituting the electronic form 230). In response to commands from the terminals having the access rights to the databases 2 to 4, the electronic form data stored in the databases 2 to 4 can be rewritten on the basis of the data in the modified objects 221.

In the process shown in FIG. 8, the server 1 creates data in the object format using the data of the report file having the optional format, and defines hierarchal access rights to the users' terminals in order to gain access to the object format data.

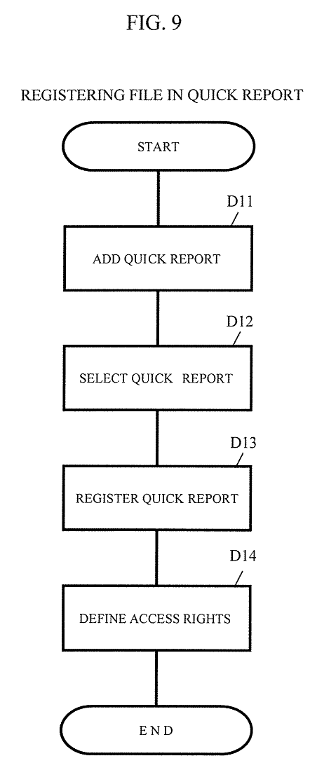

For the quick report registering process (step D1 shown in FIG. 2), the following are executed as shown in FIG. 9: addition of a file (step D11); selection of the file (step D12); registering of the data file (step D13); and defining access rights (step D14).

In step D11, the report is created using the data selected from the database and is shown on the monitor of the server 1. In step D12, the operational person of the server 1 selects one of file formats from the memory of the server 1, and determines in which file format the extracted data should be indicated. The selected file format is kept in the memory of the server 1 in step D13. The created electronic form is registered in a given format. In this state, a data file containing the electronic form data is created and stored.

In step D14, the access rights are hierarchically defined to respective users or respective user groups in order to enable them to browse/print the registered data file. For instance, if the registered data file is concerned with personnel information, the operational person at the server 1 hierarchically defines the access rights to a human resource department or a chief of personnel administration, so that a person in charge can review or print the data. Contents of the access rights are stored in the memory of the server 1. The access rights are narrowed when the terminals gain access to the data file via the Internet compared with cases in which the terminals access the data file via the LAN.

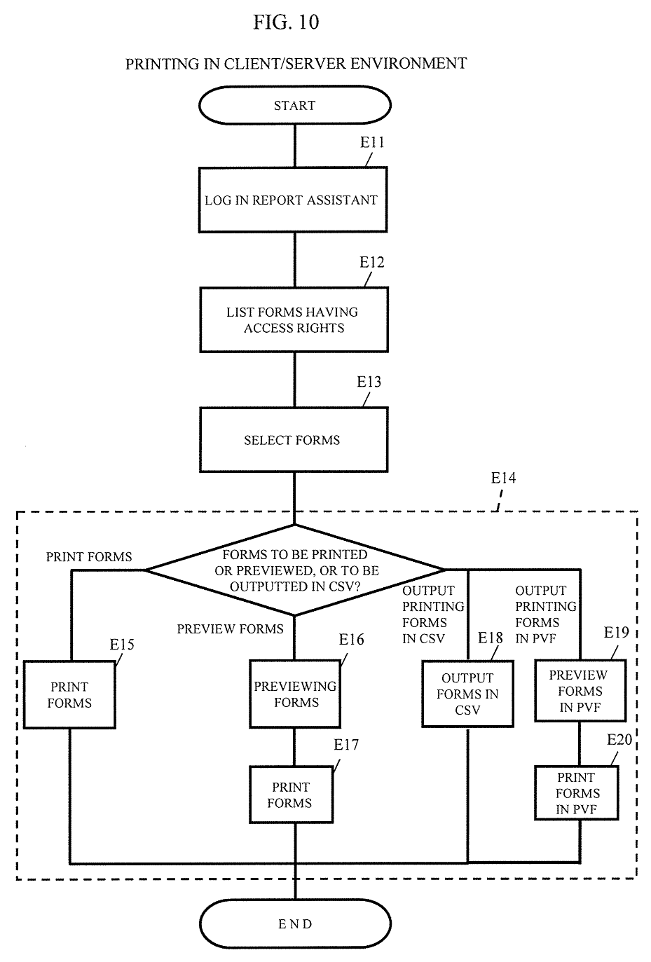

FIG. 10 shows the contents of the browse/print process executed when a terminal gains accesses to the server 1 via the LAN 9 in the client/server environment. The user's terminal is allowed to log onto the server 1 as a report assistant in step E11. A list of electronic forms to which the terminal has the access right is shown in step E12. In step E13, one of electronic forms is selected, and an output method is selected in step E14.

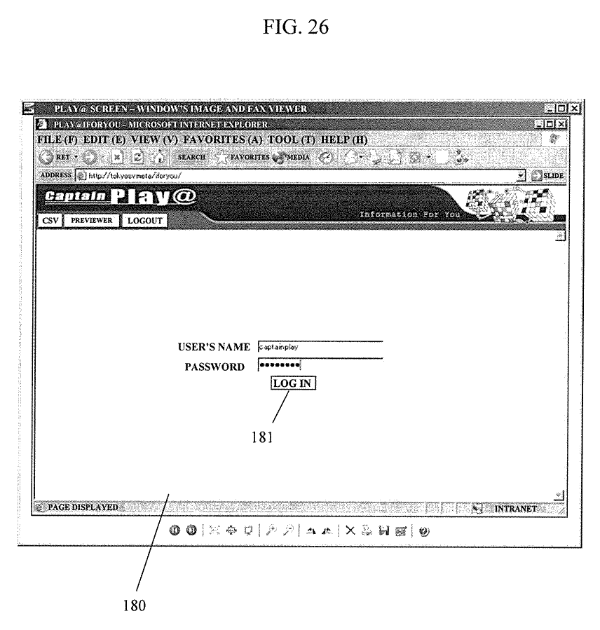

During step E11, a login screen 180 appears on the monitor of the terminal as shown in FIG. 26. The user enters his or her name and password on the login screen 180, and clicks a login button 181 in order to send them to the server 1. The server 1 checks whether or not the received user's name and password agree with the stored data. When confirming that the user has been registered, the server 1 allows the user's access, and checks the user's access right.

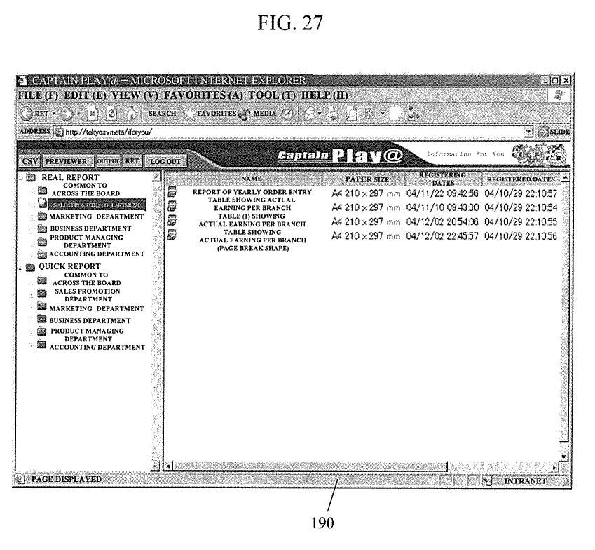

In step E12, a list of electronic forms to which the user has the access right is shown on a screen 190 of the user's terminal (shown in FIG. 27). In step E13, the user determines whether the electronic form shown on the screen 190 should be outputted as a real report or a quick report. In step E14, the following are executed: printing the electronic form (step E15); previewing the electronic form (step E16); or outputting the electronic form in the CSV format (step E18). The electronic form previewed in step E16 is printed in step E17. The electronic form in the CSV format (in step E18) or the electronic form in the PVF format (in step E19) will be printed in step E20. The processes shown on the monitor of the user's terminal will be executed.

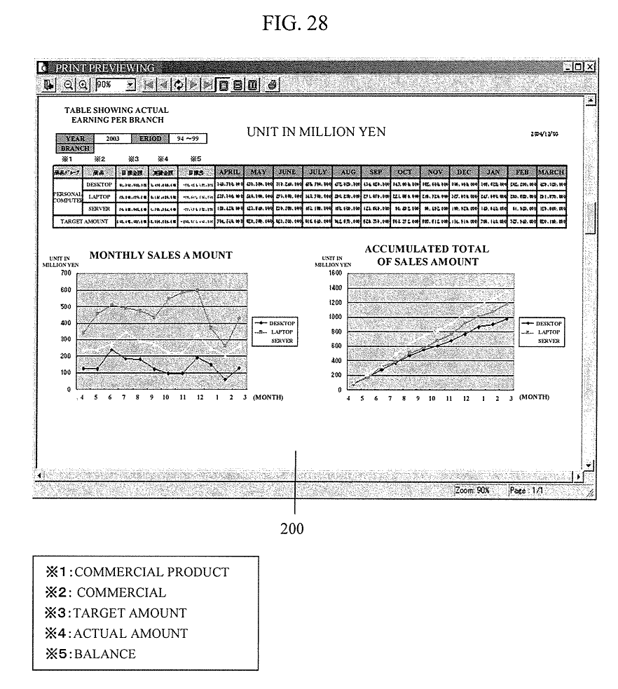

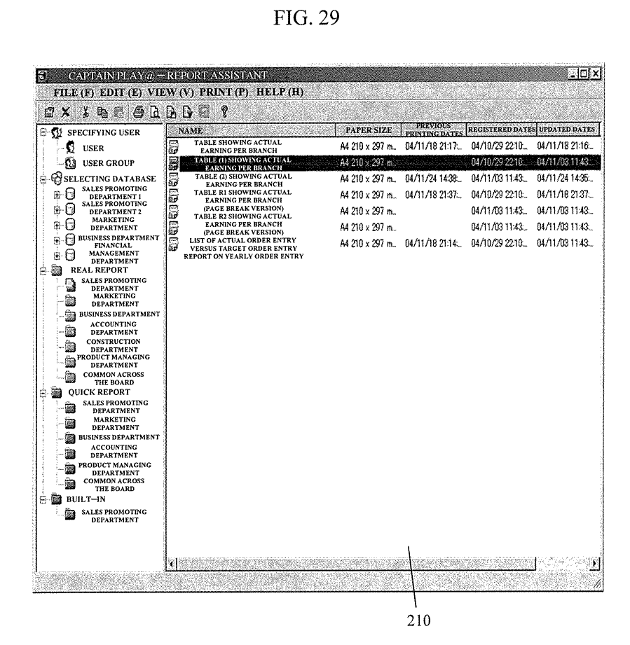

In step E15, the electronic form as shown on the screen 190 is printed by the printer 5 (refer to FIG. 1). In step E16, a preview screen 200 appears the monitor of the user's terminal (refer to FIG. 28). If the user wishes the electronic form as is shown on the preview screen 200, he or she clicks a print button (not shown). In step E17, the printer 5 will print the data on the screen 210 (shown in FIG. 29).

If the user selects the CSV format in step E18, the electronic form on the screen 200 (FIG. 28) is changed to the CSV format, and is printed by the printer 5.

When the user selects the PVF format in step 19, the electronic form 230 in the PVF format appears on the screen 220 (shown in FIG. 22). If the user wishes the electronic form 230 as it is, he or she clicks the print button (not shown), so that the electronic form 230 will be printed by the printer 5 in step E20.

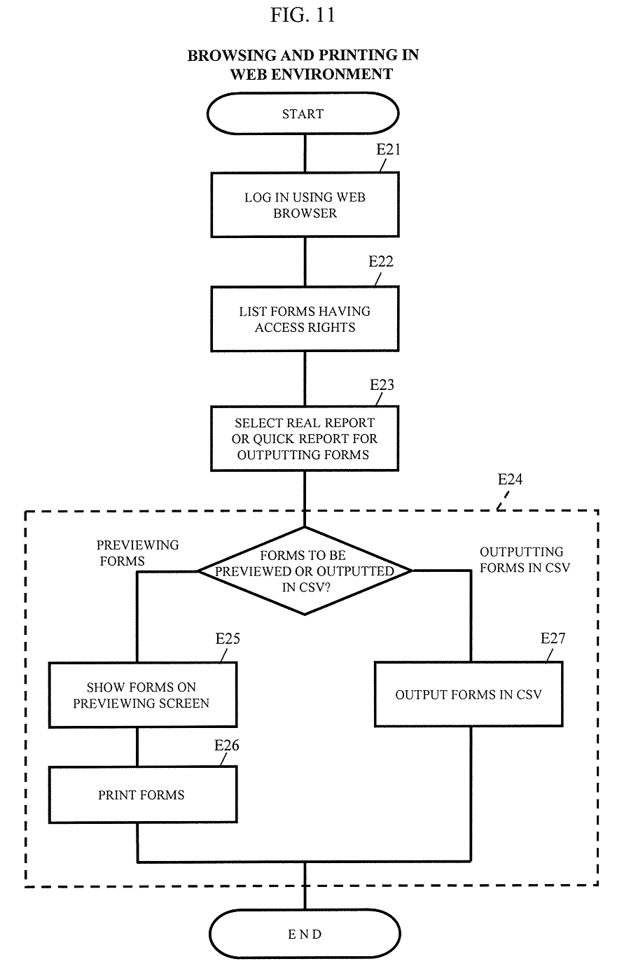

FIG. 11 shows details of the browse/print process executed when the terminal accesses the server 1 via the Internet 10, i.e., in the Web environment. In step E21, the user logs into the server 1 via the Web browser as shown in FIG. 11. A list of electronic forms to which the user has the access right is shown in step E22. A desired electronic form is selected in step E23. An output format of the electronic form is determined in step E24.

In step E21, the login screen 180 (shown in FIG. 22) appears on the monitor of the user's terminal. The user enters his or her name and password on the login screen 180, and clicks the login button 181. The user's name and password are sent to the server 1, which checks whether or not the received name and password agree with the stored data. When the user has been registered, the server 1 identifies the user and allows the user's access. Further, the server 1 checks the user's access right.

In step E22, the screen 210 (shown in FIG. 29) appears on the monitor of the user's terminal, and shows the data files and electronic forms to which the user has the access right. In step E23, the user determines whether the electronic forms on the screen 210 should be outputted as the real report or the quick report. In step E24, the following are executed. The electronic form is previewed in step E25, and is then printed in step E26. If the user desires the electronic form in the CSV format (step 27), a CSV selection screen appears on the monitor of the user's terminal. The electronic form will be outputted in the CSV format.

In step E25, the preview screen 200 appears on the monitor of the user's terminal as shown in FIG. 28. When the user desires the electronic form shown on the preview screen 200, he or she clicks the print button (not shown), so that the electronic form will be printed by the printer 5 in step E26. If the user desires the electronic form in the CSV format, the electronic form shown on the screen 200 (shown in FIG. 20) is changed into the CVS format, and is stored.

It is assumed here that the user gaining access to the server 1 via the Internet has the access right to enable him or her only to enjoy the previewing process in step E25. It is possible to prevent such a user from printing or storing the electronic forms, or outputting the electronic forms in the CSV format. In other words, the user has a narrowed access right when he or she accesses the server via the Internet 10.

Further, the users who are accessible to the server 1 have the hierarchical access rights to the electronic form data and/or data files. The electronic form data and/or data files are shown on the users' terminals in accordance with the hierarchical access rights. In addition, electronic forms data and/or data files which are not covered by the users' access rights are not shown on the monitor of the users' terminals. Therefore, users without the access rights cannot alter the electronic forms data or data files, or delete them. This is effective in improving the safety of the electronic forms preparing and controlling system.

Existing memories are utilized as the databases 2 to 4 for the server 1 to select the data of electronic forms. It is not necessary to re-input the data in the databases when preparing new electronic forms. This is effective in preparing the electronic forms at a reduced cost.

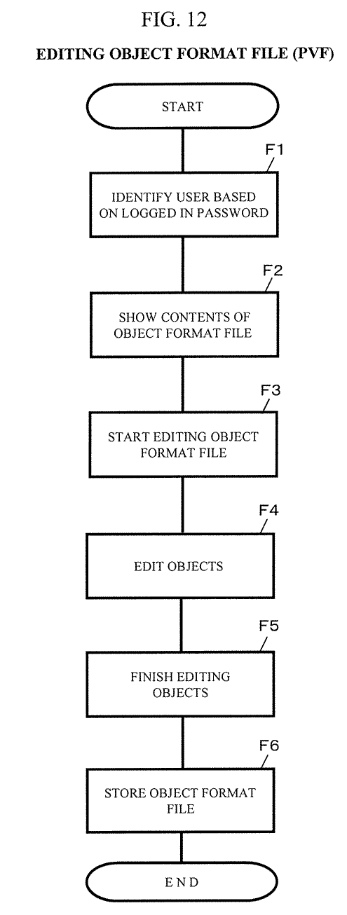

The electronic form 230 in the object format file (PVF) will be edited by a process shown in FIG. 12.

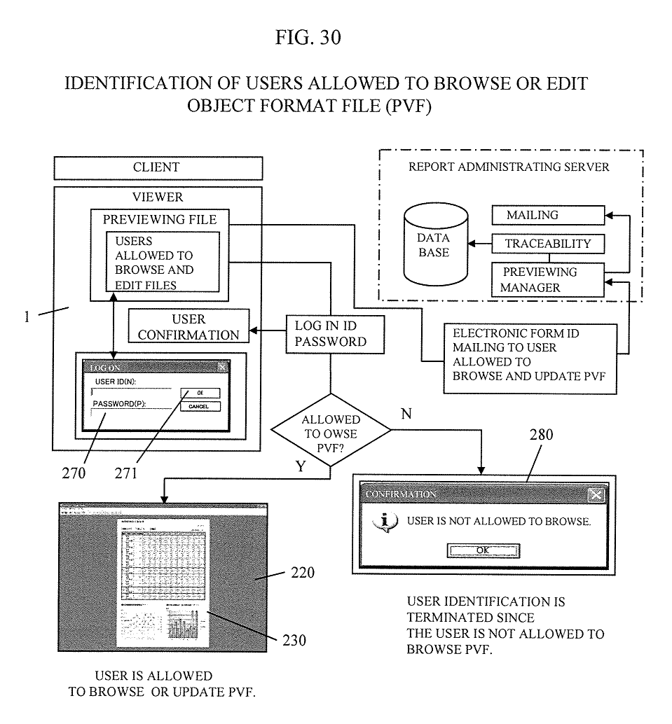

The user is identified in step F1. For this purpose, a login screen 270 appears on the monitor of the user's terminal as shown in FIG. 30. The user enters his or her ID and password on the login screen 270, and clicks an “OK” button 271. The server 1 compares the user's ID and password with the ID and password in the object format file (PVF). When the user is identified to be registered, step F2 is executed. Specifically, the screen 220 showing the electronic form 230 appears on the user's terminal, which allows the user to browse and change the electronic form 230. If no agreement is accomplished with respect to the user's ID and password, a screen 280 (shown in FIG. 29) appears on the monitor of the user's terminal. No further steps will be executed since the user is not allowed to browse the object format file (PVF).

When the electronic form 230 is shown, step F3 is executed. A mode for editing the objects 221 (shown in FIG. 22) in the electronic form 230 is initiated. In step F4, the user edits the objects 221 within a scope where the user is entitled. When the editing is finished, the foregoing mode is completed. The data of the edited electronic form 230 in the object format is stored in the object format file.

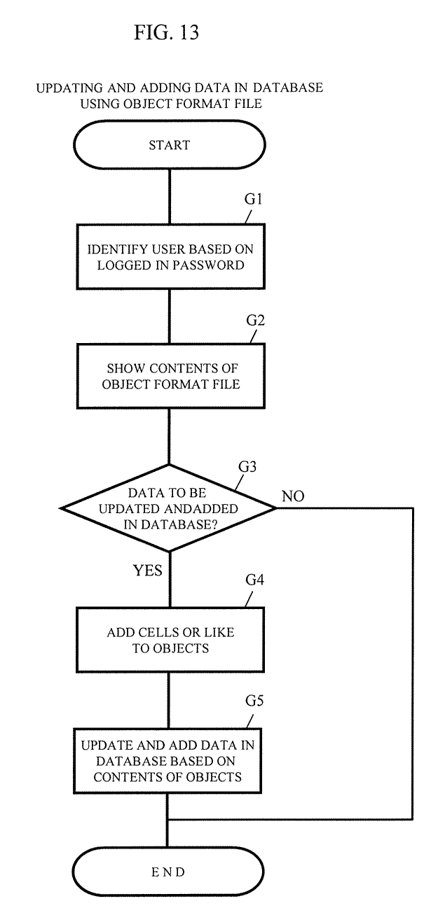

Data of the electronic form 230 (constituted by the object format file) is changed and added in the databases 2 to 4 according to processes shown in FIG. 13.

In step G1, the user's identification is executed. Similarly to step F1 shown in FIG. 12, the login screen 270 is shown on the monitor of the user's terminal. The user enters his or her ID and password, which are identified. A process in step G2 is executed, so that the screen 220 showing the electronic form 230 appears on the user's terminal. In this state, the user is allowed to browse and change the electronic form 230. The screen 280 (shown in FIG. 30) appears on the monitor of the user's terminal. If the user's ID and password are not in agreement with those stored in the server 1, the user does not have a right to browse the object format file (PVF), so that the foregoing process is terminated

Once the electronic form 230 is shown, a process in step G3 (FIG. 13) will be executed in order to check whether or not updating and addition of the data in the databases 2 to 4 are required. If neither data updating nor adding is required, the process is terminated. Conversely, when the data updating and adding are required, a process in step G4 will be executed. The user changes data in the electronic form 230 or adds new data to the objects 221. In step G5, the changed and added contents are rewritten over the data stored in the databases 2 to 4. Further, the new items are added to the objects 221.

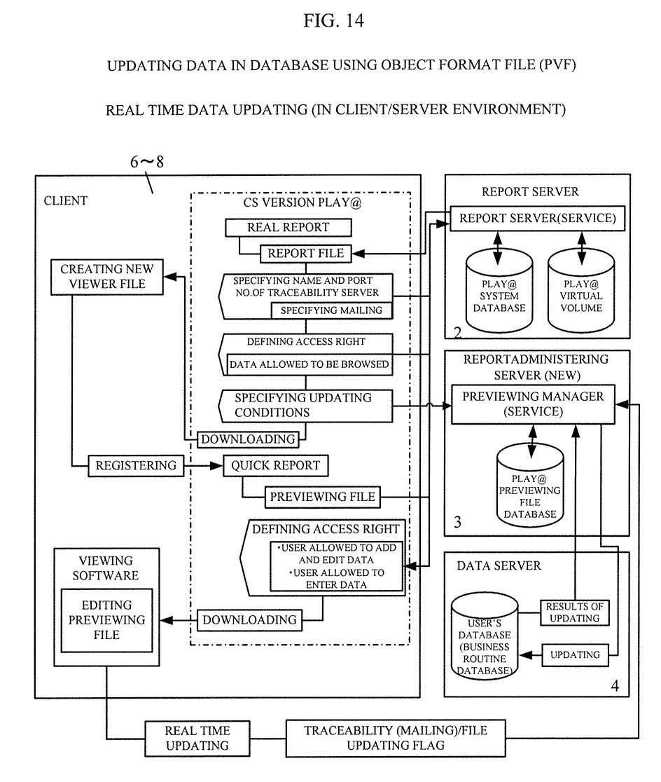

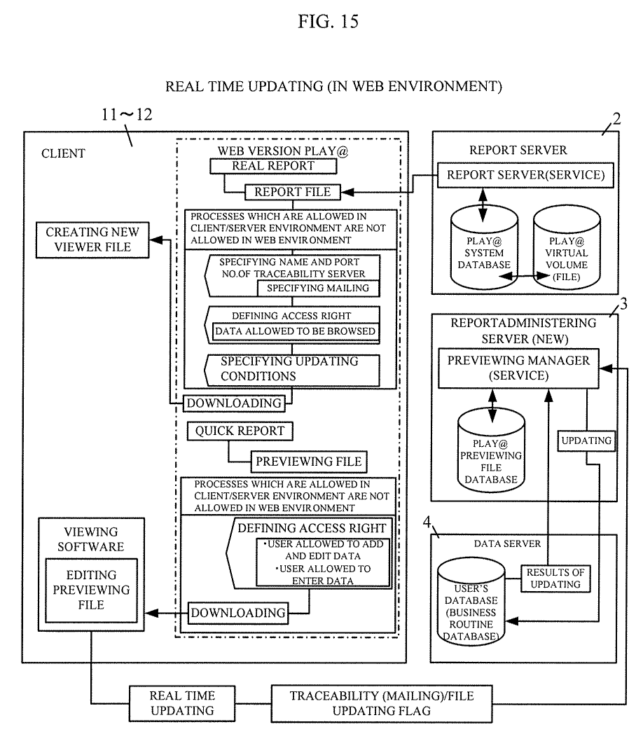

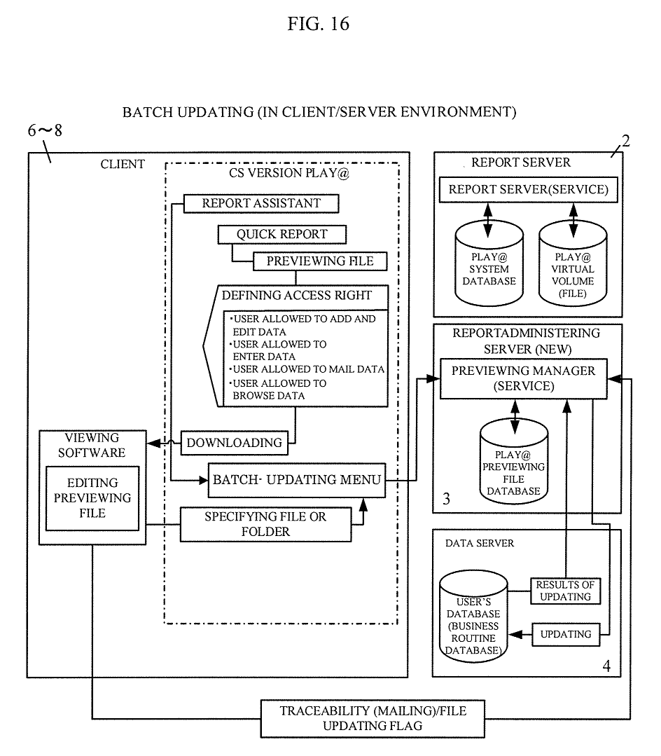

In step G5, the terminals 6 to 8 change or add data via the LAN 9 or via the Internet 10 as shown in FIG. 14 and FIG. 16. FIG. 14 shows how data in the object format file is changed and added in the databases 2 to 4 on the real time basis in the LAN environment. FIG. 15 shows how data in the object format file is changed and added in the databases 2 to 4 on the real time basis in the Web environment. In short, data in the databases 2 to 4 can be changed and added using the object format file both via the LAN and the Internet 9. Further, the terminal 11 performs the data updating and data adding via the Internet 10. Further, the data can be changed or added in the databases 2 to 4 for a plurality of object format files by the batch processing as shown in FIG. 16.

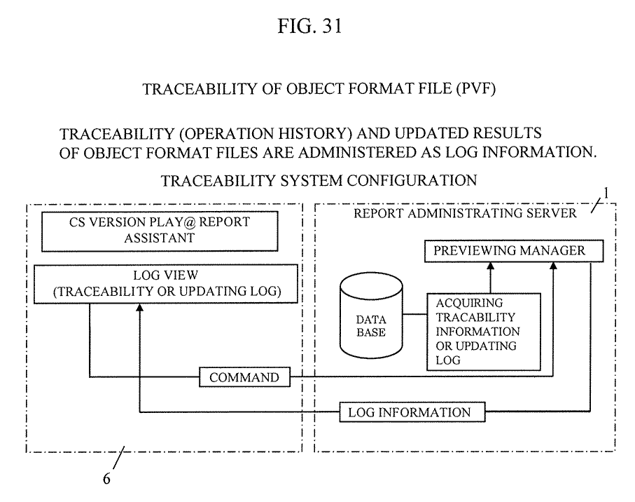

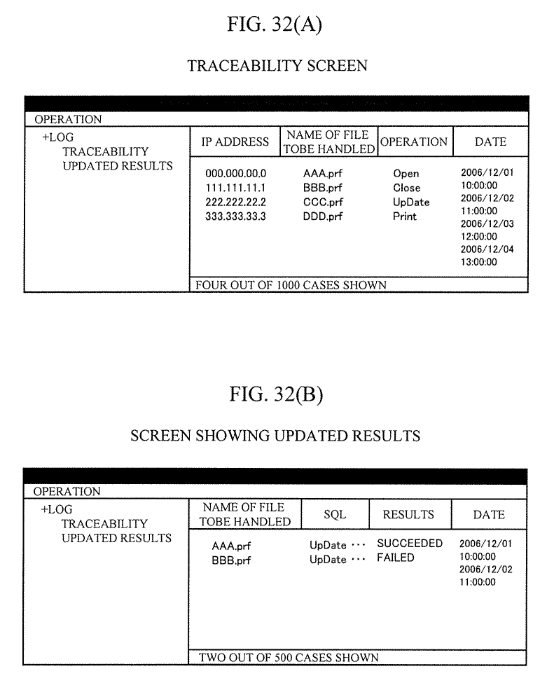

The electronic forms preparing and managing system ensures the traceability for the object format files (the electronic forms 230) as shown in FIG. 31, thereby administering operation histories and updating results of the electronic forms 230 as log information. It is assumed here that the electronic form 230 shown on the monitor of the terminal 6 having the access right is to be changed. An updating command appears on the monitor of the terminal 6. When the command is executed, contents of the updating command are sent to the server 1. The server 1 stores a name of the object format file to be changed, an IP address of the terminal 6 requesting the data updating, details of the terminal 6, and a clock time of data updating. FIG. 32(a) shows a screen which appears on the monitor of the terminal 6 and shows the operation history while FIG. 32(b) shows a screen showing results of the data updating.

Observing the operation history and the results of the data updating on the electronic form 230, the user can know changed items or changed time. The screens shown in FIG. 32(a) and FIG. 32(b) may show the operation history or results of the data updating of the respective objects 221 for the electronic form 230. In such a case, object information (positional information) as well as file names may be controlled.

According to the invention, the data on the electronic form 230 of the optional format are changed into data in the object format. The users' terminals are hierarchically assigned access rights to the object format data. The object format data (the objects 221) on the electronic forms 230 can be changed or modified in accordance with the access rights of the users' terminals.

The user's terminal can gain access to the databases 2 to 4 in accordance with the access rights. In response to a command from the user's terminal having the access right to the databases 2 to 4, the changed object format data (objects 221) can be rewritten as electronic forms data stored in the databases 2 to 4. This guarantees the uniformity of the data, and enhances usability.

Each user's terminal can access the databases 2 to 4 in accordance with the access right. In response to a request from the terminal, new data tables are created in order to store new data in the databases 2 to 4, and an object data inputting area is created on the electronic form 230 in accordance with the data tables. Therefore, new data can be added to the electronic form 230 and to the databases 2 to 4. Compared with development of the existing electronic forms preparing and controlling systems, no complicated configuration is necessary for the electronic forms preparing and controlling system according to the present invention. This is effective in reducing a development cost of the system, and in preparing, managing and modifying electronic forms with ease.

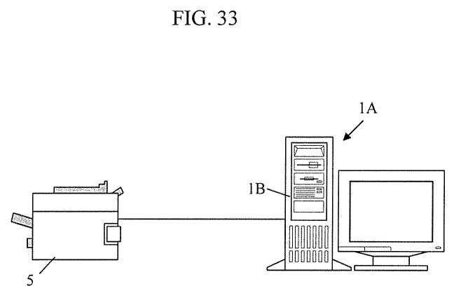

In addition to the foregoing client/server configuration, the electronic forms preparing and controlling system may be accomplished using one computer 1A as shown in FIG. 33. In this case, the computer 1A is provided with an electronic forms preparing and controlling program. The computer 1A can execute the following: selecting data for an electronic form from a database B; preparing the electronic form in an optional format using the selected data; showing the prepared electronic form on a monitor; changing the electronic form data into object format data; hierarchically defining access rights to the object format data; and changing the object format data in accordance with the access rights.

Specifically, the computer 1A functions to create object format data using the data on the electronic form 230, and hierarchically defines access rights to the object format data. This configuration is effective in safely changing the data on the electronic form 230, and in preparing and controlling the electronic forms.

What is claimed is:

1. An electronic forms preparing and managing system in which electronic forms data are selected from a memory of a computer, new electronic forms having an optional format are prepared using the selected data, and are shown on a monitor of the computer, the electronic forms preparing and managing system comprising a data crating unit changing the optional format data on the electronic forms into object format data, and a unit hierarchically defining access rights to the object format data.

2. The system according to claim 1, wherein the object format data are changed in accordance with the access rights.

3. An electronic forms preparing and managing system in which electronic forms data are selected from a memory of a computer, new electronic forms having an optional format are prepared using the selected data and are shown on a monitor of a user's terminal accessible to the computer via a network, the electronic forms preparing and managing system comprising: a data preparing unit changing an optional format data into object format data, and a unit hierarchically defining an access right to the user's terminal, which allows the user's terminal to gain access to the object format data.

4. The system according to claim 3, wherein the object format data are changed in accordance with the access right of the user's terminal.

5. The system according to claim 4, wherein the user's terminal is accessible to memories in accordance with the access right thereof; and the forms data stored in the memories are changed into object format data in response to a command from the terminal having the access right to the memories.

6. The system according to claim 3, 4 or 5, wherein the user's terminal is accessible to the memories in accordance with the access right thereof; and in response to a command from the user's terminal, a data table for storing new data in the memory, and an object data input region corresponding to the data table are created on the electronic form.

7. An electronic forms preparing and managing program installed in a computer and enabling the computer to execute the following:
selecting electronic forms data from a memory;
preparing electronic forms of an optional format on the basis of the selected data:
showing the electronic forms on a monitor;
changing the electronic forms data of the optional format into object format data; and
hierarchically defining access rights to the object format data.

8. The program according to claim 7 further enables the computer to change the object format data in accordance with the access right.

9. An electronic forms preparing and managing program installed in a computer and enabling the computer to execute the following:
selecting electronic forms data from a memory;
preparing electronic forms of an optional format on the basis of the selected data:
showing the electronic forms on a monitor of a user's terminal accessible to the computer via a network;
changing the electronic forms data of the optional format into object format data; and
hierarchically defining an access right for the user's terminal to access the object format data.

10. The program according to claim 9 enabling the computer to change the object format data in accordance with the access right of the user's terminal.

11. The system according to claim 10 enabling the computer to perform the following:
allowing the user's terminal to gain access to a memory in accordance with the access right; and
changing the electronic forms data stored in the memory into object format data in response to a command from the user's terminal.

12. The program according to claim 9, 10 or 11 enabling the computer to execute the following:
allowing the user's terminal to gain access to the memory in accordance with the access right; and
creating an area where object format data corresponding to the data table are inputted on the electronic forms in response to the command from the user's terminal.

13. A recording medium in which the program defined in any one of claims 7 to 11 is stored.
